(19) United States
(12) Patent Application Publication
(10) Pub. No.: US 2013/0025464 A1
(43) Pub. Date: Jan. 31, 2013

(54) Safety Mechanism for Beverage-Making Devices and the Production Method Thereof

(71) Applicant: Hendrik Meyl, Munchen (DE)

(72) Inventor: Hendrik Meyl, Munchen (DE)

(21) Appl. No.: 13/380,052

(22) PCT Filed: Jul. 1, 2010
(86) PCT No.: PCT/EP2010/003978

§ 371 Date: Dec. 22, 2011

(30) Foreign Application Priority Data
Jul. 6, 2009 (DE) 10 2009 031 757.0
Jun. 29, 2010 (DE) 10 2010 025 398.7

(51) Int. Cl. A47J 31/34; B23P 17/04

(52) U.S. Cl. 99/280; 29/428

(57) ABSTRACT

The invention relates to a safety mechanism for beverage-making devices that extract or dissolve a beverage base material using a hot pressurized liquid. The pressure container of the beverage-making device comprises an inwardly directed crucible-shaped formation, into which the pressure-regulating mechanism is inserted from the outside and which is closed with a closure in a planar manner. The closure does not have any holes, but form intermediate spaces with the pressure container that act as vapor drainage channels. The outlet of the gases on the beverage-making device is located almost invisibly at a transition of two parts.

The present application claims priority of German patent application DE 10 2009 031 757 filed on 6 Jul. 2009 and DE 10 2010 025398 filed on 29 Jun. 2010.

### FIELD OF THE INVENTION

The invention relates to the field of beverage preparation, in particular the preparation of a hot beverage with a hot liquid under pressure.

### SUMMARY AND RELATED ART

The use of a liquid under pressure for extraction of a beverage base substance leads to an increased need for safety measures. A paramount aspect herewith is the limitation of the pressure within a brewing container. A brewing liquid is provided inside the brewing container at the start of the preparation of the beverage and is brought to the desired state therein.

Two approaches are normally possible: the limitation of the pressure increase and the controlled reduction of pressure. Measures for an automated pressure reduction a requisite since the user often cannot sufficiently supervise the brewing process or often simply disregards the limitation of the pressure increase in a reliable manner.

For the assessment of the necessity of a pressure regulating mechanism in particular the way of preparing an espresso is regarded. A typical espresso has a volume between 22.5 ml and 27.5 ml and is produced by an extraction of 6.5 g to 7.5 g of evenly fine grinded beverage base substance of strongly roasted coffee beans (espresso roasting) for about 22.5 to 27.5 seconds with of hot brewing liquid at about 86° C. to 90° C. under a pressure of 800 kPa to 1 MPa. The beverage temperature in the reception container is ideally between 64° C. and 70° C.

The pressure limitation is achieved by a controlled discharge of gases and/or liquids generated in the brewing container.

The U.S. Pat. No. 4,386,109 (Bowen et al.) a hot beverages maker in which a commercially available pressure control valve with ball and spring is implemented. A large part of the brewing container is enwrapped in order to arrange the pressure control valve therein for a stable support at the brewing container for filling.

The U.S. Pat. No. 5,884,881 (Orrico et al.) describes a pressure control valve which functions as a by-pass of the brewing chamber. A rubber sealing deflects at a predetermined pressure difference between the brewing chamber and the surroundings and opens the way for the liquid. This apparatus is suited for overpressures of up to about 414 kPa. It is a disadvantage that the brewing time is significantly reduced due to the fast deviation of the liquid, and that the pressure, at which the safety mechanism is activated is adjustable only very unprecisely due to the use of a rubber sealing.

The PCT application WO 91/12757 (Yu) discloses a coffeemaker with a two-step valve system that opens the brewing chamber depending on the pressure. When reaching the regular working pressure, the liquid barrier opens in the direction of the filter chamber and when the safety pressure is exceeded, a gas barrier opens towards the atmosphere. The opening levels of the valves are adjusted connected to each other by the user by adjusting the bias of the spring in the valve system. As a consequence, the safety pressure can be adjusted very differently which has significant consequences for the brewing process and consequently for the quality of the beverage. Furthermore, the modification of the safety pressure by the user is precarious for safety reasons.

The published US patent application US 2004/0020922 (Alves) describes a one-chamber beverage maker that comprises a pressure control valve in the brewing container. The valve is a hole in the bottom of the brewing container which is closed by an elastic plastics pin with a semispherical lock. This mechanism only allows a rough regulation of the overpressure. In addition, this apparatus depends strongly on tolerances in the manufacturing and aging of the elastic plastics pin by which the operability of the safety mechanism cannot be insured for extended periods.

The German patent publication DE 3742507 (Hirsch) describes a safety mechanism in which the detachment of the lock of the brewing container leads to the exit of the content of the brewing chamber. The use safety of the beverage maker is hereby ensured but at the cost of the prepared beverage. After activation of the safety mechanism this is no longer consumable because it is contaminated by the lock and the coffee ground.

The European norm EN 13248:2002 describes household coffeemakers with a safety device which is inserted as a separate element and is arranged exactly at the point where the vapor is generated in the beverage maker. The pressure in the brewing container is maximum 400 kPa.

A possible heating method in the preparation of hot beverages is the use of electromagnetic radiation. Herein, the shielding of elements, which are not to be heated, has to be considered. Existing methods, as for example described in the U.S. Pat. No. 2,601,067 (Spencer) and U.S. Pat. No. 4,386,109 (Bowen et al.), are the use of a solid metal or a conducting coating in order to shield the corresponding areas from the electromagnetic radiation. The property of electromagnetic radiation that it cannot propagate through openings which are below a certain size.

Finally, it is to be noted that the design, that is the aesthetic impression and the haptics of the espresso maker, is in all known applications strongly determined by the technical apparatus. A wide separation of the design and the technical functions of the beverage maker have not been possible until now. This is, within others, due to the use of a preassembled and attached, non-integrated safety mechanism and has the consequence that the apparatus' are often very unaesthetic and therefore do not find an acceptance on the market.

It is an object of the invention to improve the safety of beverage makers, in particular of beverage makers that extract or dissolve a beverage base substance with a hot liquid under pressure.

It is another object of the invention to provide a safety mechanism which works reliable under higher brewing pressures in a passive, i.e. a state which does not control the pressure, as well as in its active state, i.e. a state which controls the pressure.

It is a further object of the invention to obtain a cost effective and error-free manufacturing method for safety mechanisms in beverage makers.

It is also an object of the invention to improve the appearance of beverage makers and to provide more space for the styling.

The invention has an application in all beverage makers which comprise a pressure container or in which a preparation process in which a usually pressure free container can come under pressure.

Equally, the invention may be used in all hot beverage makers, with an independent energy source i.e. not forming part of the maker, or a dependent energy source, i.e. forming part of the maker. Herein the necessity with a beverage maker which extract or dissolve a beverage base substance with a hot liquid under pressure is evident.

In particular, the invention has an application with smaller systems that exclusively prepare single servings of the beverages. The single serving of the beverage is an amount that is prepared for exactly one person for the direct consumption.

The invention is also applicable to beverage makers that work with electromagnetic radiation as heating source.

### SUMMARY OF THE INVENTION

The invention is a safety mechanism for beverage makers that extract or dissolve a beverage base substance with a hot liquid under pressure. The pressure container of the beverage maker comprises a bowl-shape form oriented inwardly in which the pressure control mechanism is inserted from the outside and is locked smoothly for planar with a lock. The lock does not comprise openings or holes but forms with the pressure container a clearance which functions as vapor deviation channels. The outlet of gases at the beverage maker is almost invisible at the transition of two parts.

### BRIEF DESCRIPTION OF THE DRAWINGS

FIGS. 1 to 15 show different examples of the invention:

FIG. 1 shows a first example of the invention;

FIG. 2 shows an exploded view of the first example of the invention;

FIG. 3 shows the section A-A in FIG. 1;

FIG. 4 shows the section B-B in FIG. 1;

FIG. 5 shows a second example of the invention which may be used with a heating source emitting electromagnetic radiation;

FIG. 6 shows a third example of the invention along the section in FIG. 7;

FIG. 7 shows the third example of the invention along the section in FIG. 6;

FIG. 8 shows an exploded view of the third example of the invention;

FIG. 9 shows a top view on the brewing container of the third example of the invention without lock;

FIG. 10 shows the lock of the third example along the section of FIG. 8;

FIG. 11 shows a fourth example of the lock;

FIG. 12 shows a fifth example of the invention;

FIG. 13 shows the lock of the fifth example of the invention just cut above the safety mechanism;

FIG. 14 shows the brewing container for the fifth example of the invention;

FIG. 15 shows the fifth example of the lock at activation of the safety mechanism.

### DETAILED DESCRIPTION

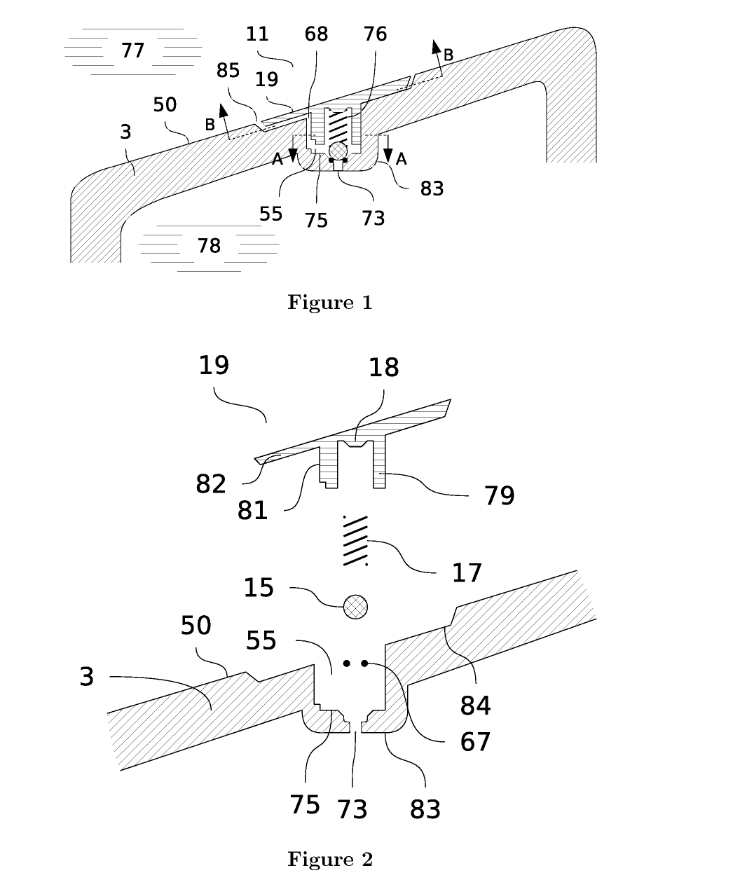

The section of a brewing container (3) shown in FIG. 1 shows an example of the safety mechanism (11) according to the invention. FIG. 2 shows an exploded view of the safety mechanism (11). The brewing container (3) comprises a bowl-shaped recess (55) which has its bottom (75) on the side facing towards the interior of the brewing container (78) and which is open at the side facing towards the atmosphere (77). If the thickness of the brewing container wall is not sufficient to take up the entire safety mechanism (11), there is the possibility to provide enough material for enclosing the bowl-shaped recess (55) by the use of a substantially cylindrical attachment (83) at the side of the interior of the brewing container (78).

The bottom (75) of the recess (55) comprises at least one hole (73) which enables the exchange of gases and/or liquids between the interior of the brewing container (78) and the bowl-shaped recess (55) such that the pressure in the interior of the brewing container (78) remains, at the predetermined heating power of the heating device, below the predetermined safety pressure.

A pressure-regulating mechanism (76) is inserted in the recess (55) which regulates by opening the pressure in the interior of the brewing container (78) at or below the predetermined heating power of the heating device such that the pressure remains below the predetermined safety pressure. The bowl-shaped recess (55) is closed by a lock (19) which locks the pressure-regulating mechanism (76) in the recess (55).

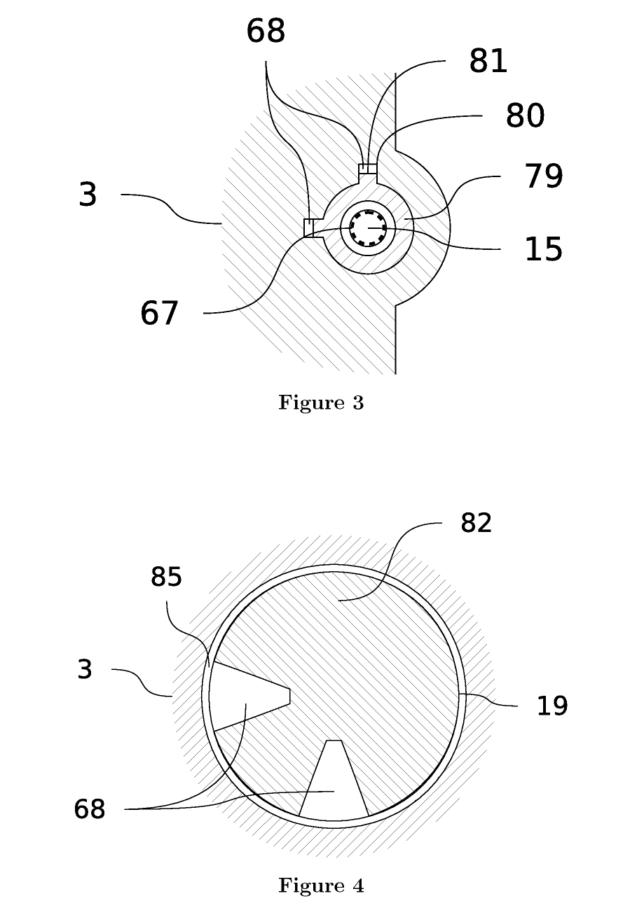

As also shown in FIGS. 3 and 4, the lock (19) does not comprise any holes. These holes are usually used for deviating the vapor when opening the pressure-regulating mechanism (76). One or more vapor deviation channels (68) are formed instead for deviating the vapor between the brewing container (3) and the lock (19), which lead to vapor outlet slits (85) at the outer side of the brewing container. These vapor deviation channels (68) are in the examples of the invention shown herein a continuation of the guiding grooves (80) (see below), but they can have any form.

The lock (19) consists of a locking screen (82) to which a hollow open cylinder (79) is fixedly attached. This cylinder (79) clamps the lock (19) fixedly in the recess (55) of the brewing container (3) and contains the pressure-regulating mechanism (76). Other types of fixation of the lock (19) are possible, for example by soldering of components or by the use of a thread. The locking screen (82) fits in a recessed trough (84) in the brewing container, such that the surface (50) of the brewing container (3) remains planar, i.e. surface (50) of the brewing container (3) and locking screen (82) form a substantially planar surface. If the design of the brewing container (3) is different, then the screen (82) can be adapted accordingly. It is to be noted that the locking screen (82) can be designed differently compared to the examples shown herein. In particular, is to be noted that the locking screen (82) is exactly as large as the basis of the cylinder (79).

One or more guiding rails (81) are attached to the cylinder (79) which engage in corresponding guiding grooves (80) within the recess (55). These guiding rails (81) are arranged such that the lock (19) can be inserted in exactly one way into the brewing container (3) and it orients automatically within certain limits during mounting in order to reduce the error-proneness of the mounting. The latter can be improved by the design of the guiding rails (81), for example by tapering them towards the lower end.

The pressure-regulating mechanism (76) consists, in the shown examples, of a valve ball (15) which is pressed against the hole (73) by a biased spring (17). An O-ring (67) is inserted for an improved sealing between hole (73) and ball (15) which can also be omitted, depending on the working environments of the safety mechanism (11). In order to maintain the spring (17) more precisely at its place, for example because the spring is smaller than the locking cylinder, a spring support (18) can be optionally used which has for example, the form of a truncated cone and the spring (17) lies against the side and is centered thereby.

In case the pressure in the interior (78) of the brewing container (3) is increased, such that the force of the vapor pressure which acts on the ball (15) is larger than the bias of the spring (17), the ball (15) is elevated and gives the way free for the vapor from the interior of the brewing container (78) via the vapor deviation channels (68) towards the atmosphere (77).

A non-shown alternative of the pressure-regulating mechanism (76) is that the lock (19) is attached in the recess such that the lock (19) is elevated when the control pressure is exceeded, and the way between the interior of the brewing container (78) and the atmosphere (77) is thus opened. Here different embodiments are possible, for example that the movement is controlled by a spring, that the mechanism has to be reset manually by a user, or that the lock (19) is entirely removed from the brewing container (3).

Another non-shown example of the invention is extending the above described mechanism by a second safety stage. Herein, the bottom (75) of the bowl-shaped formation has at least a second hole or slit which is normally closed by the inserted lock (19). In case the pressure in the brewing container increases that strongly that the primary pressure-regulating mechanism (76) is overcharged, for example by a stronger heating source as predetermined, the lock (19) is released, as described above, out of its anchoring and opens further openings or slits for the vapor deviation.

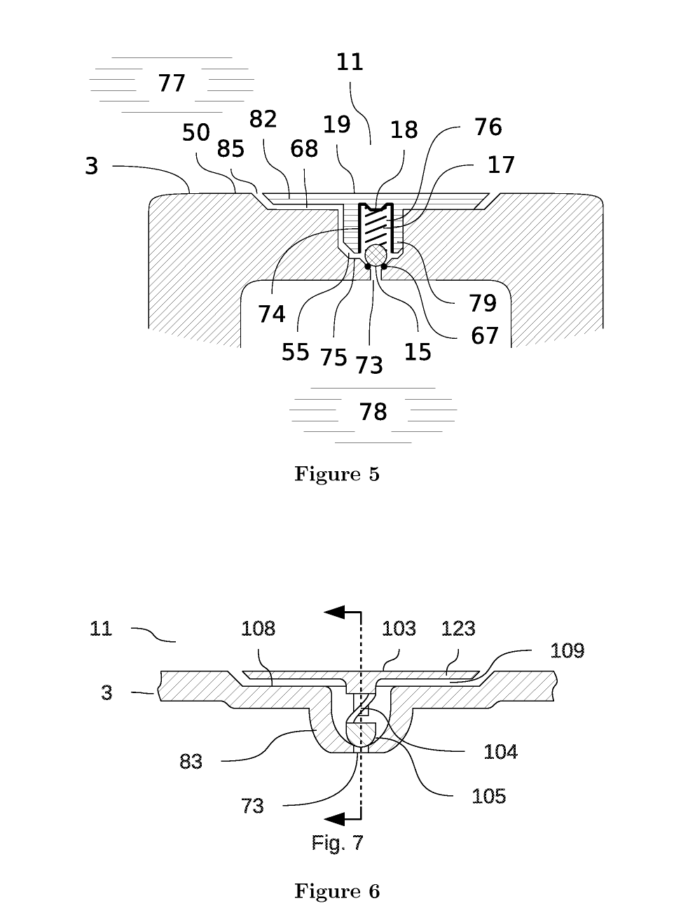

FIG. 5 shows an example of the invention which is also adapted for the use with electromagnetic radiation. Here, the pressure-regulating mechanism (76) is inserted in a cylinder (74) that is closed on one side and shields electromagnetic radiation, which is in turn inserted into the lock (19). By this shielding the use of a spring (17) of metallic material is possible in connection with electromagnetic radiation.

The safety mechanism (11) shown in FIGS. 1 and 5 can be used in beverage makers which are formed by injection molding. Thereby no specific manufacturing methods are required for the safety mechanism (11) and the manufacturing of the safety mechanism (11) is particularly cost efficient. As a removal from the mold is required in the manufacturing via molding, is in the case that the brewing container wall is inclined with respect to the removal direction as shown, also the mechanism is inclined in relation to the brewing container wall. This has as a consequence that the cylinder (79) is arranged inclined on the locking screen (82).

The selection of the material of the apparatus is usually arbitrary. The used materials should be food safe in any case and should not change the organoleptic properties of the food product.

It is also recommended to select the materials, when using electromagnetic radiation, such that as less as possible unuseful heating occurs. As shown above, in cases in which this is not possible, the heating can be reduced to an acceptable level till an entire prevention by specific shielding.

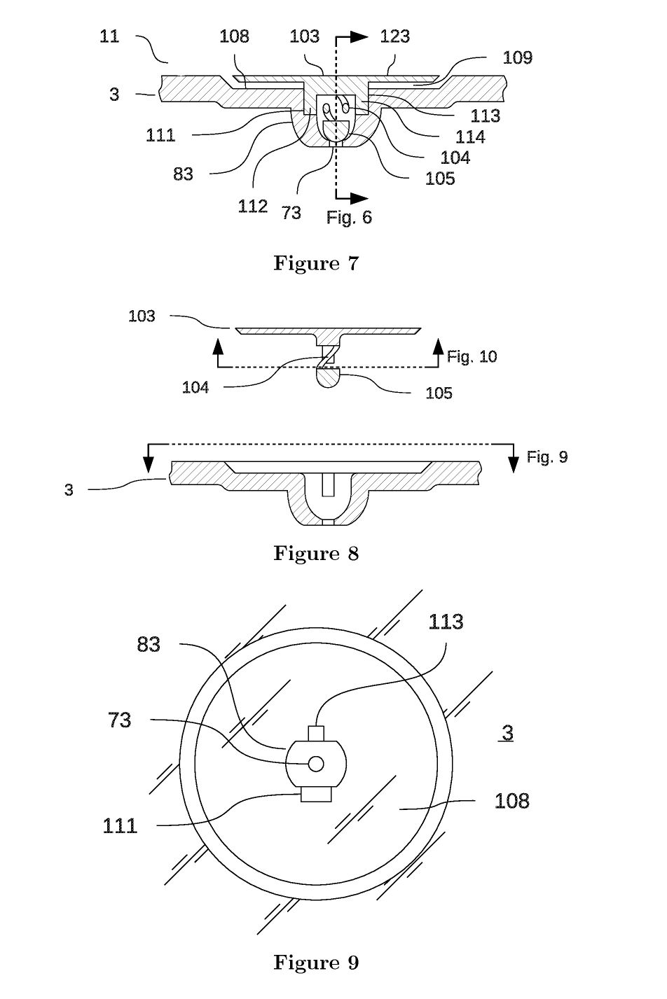

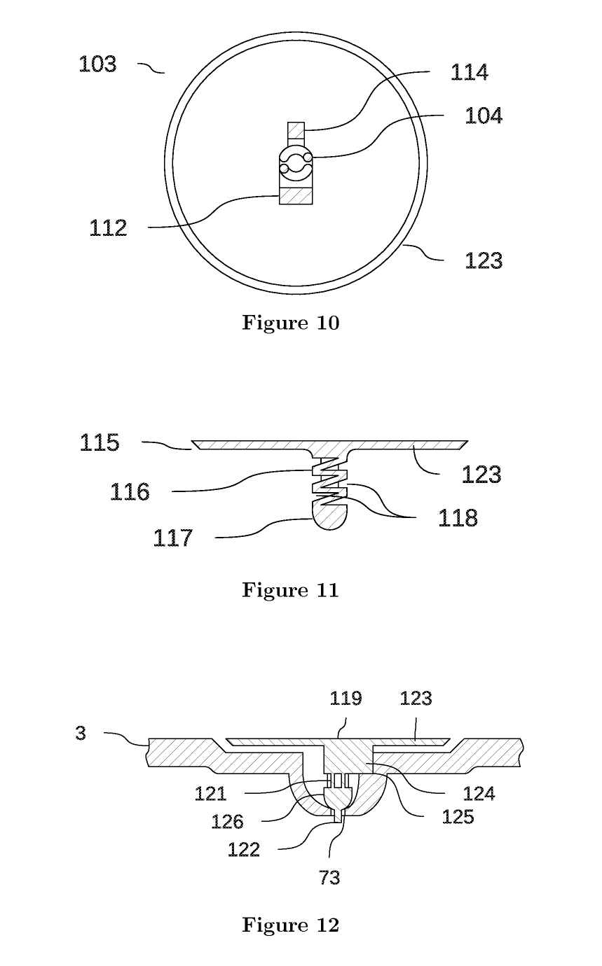

FIGS. 6 to 10 show a third example of the safety apparatus (11) of the invention. The brewing container (3) of the beverage maker comprises a bowl-shaped recess (83) with a valve opening (73) which is closed by a lock (103) such that a vapor outlet gap (109) remains free.

The lock (103) consists of a screen (123), the spring mechanism (104) and the locking mechanism (105), which are permanently attached to each other. The spring mechanism (104) connects the screen (123) with the elastic locking mechanism (105) which closes the valve opening (73). In this way, the final mounting of the safety apparatus (11) of the beverage maker is particularly simple: it consists only in the insertion of the lock (103) in the bowl-shaped recess (83) of the brewing container (3).

The lock (103) is manufactured in a single manufacturing step. This means that the lock (103) can be manufactured with one usual, universally applicable injection molding machine in a single operation. These machines can mold around inserted elements as well as use different materials.

The spring mechanism (104) is manufactured from the same material as the screen (123) and is manufactured together in one single manufacturing operation (cast). In order to avoid undercuts, the spring mechanism (104) consists of a helix with one half-turn. The locking mechanism (105) is molded from a second material (so called 2K-method) without leaving the machine.

In case the screen (123) with the spring mechanism (104) is also made from an elastic material, the entire lock (103) is manufactured in one cast.

The lock (103) contains one wide pin (112) which engages in the wide recess (111) of the brewing container (3) and a narrow pin (114) which engages in the narrow recess (113) of the brewing container (3). This ensures that the lock (103) is always mounted in the same orientation.

A fourth example of the lock (103) is shown in FIG. 11. The lock (115) consists of a screen (123) with the cylinder (116) in its center which bounces due to the conical indents (118). The end (117) of the cylinder (116) serves as a locking mechanism. Lock (115) is entirely made from elastic material.

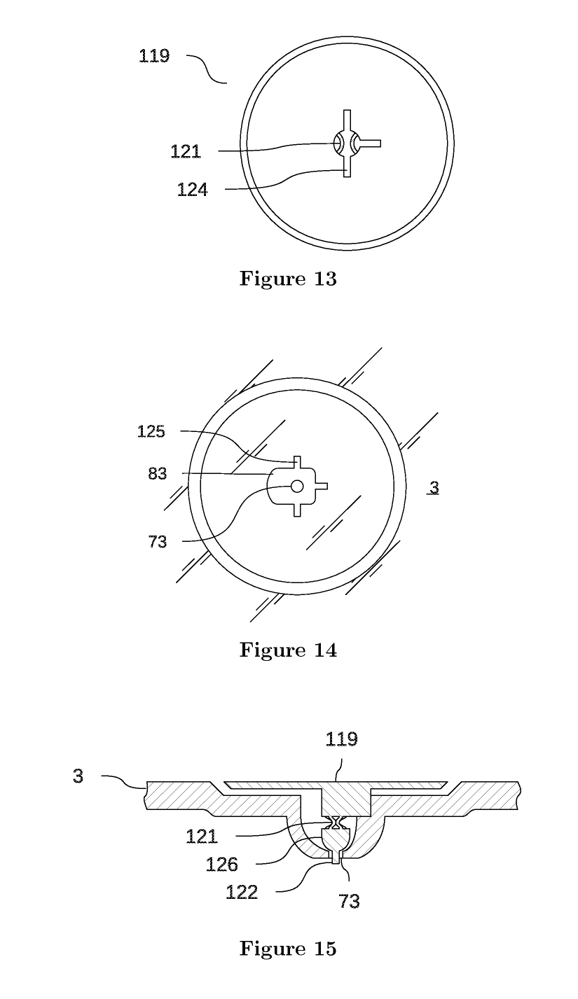

The fifth example of the invention is shown in FIGS. 12 to 14. Herein, the lock (119) is entirely formed from an elastic material and is placed together with plugging rips (124) in the corresponding recesses (125) in the brewing container (3).

The suspension occurs via the bouncing lamella (121). Their thickness and shape is determined by the precise requirements of the beverage maker. The shown lamella (121) are slightly bent, their behavior thus has an increased hysteresis.

To avoid kinking of the locking mechanism (126) and a corresponding undesired behavior, it comprises a guiding pin (122) which protrudes into the valve hole (73).

FIG. 15 shows the third example of the invention when the pressure within the brewing container (3) is above the activation pressure of the bouncing lamellae (121). The lamellae (121) bend and the locking mechanism (126) elevates. The guiding pin (122) protrudes still far enough into the valve opening (73) to provide a guiding for the locking mechanism (126).

If the brewing container (3) is made from a transparent material, the area in which the pressure-regulating mechanism is located will be provided with a structure on the inner side of the brewing container (3). This is implemented such that the technical components are not visible for the user.

1. An apparatus for limitation of a pressure in a brewing container for beverages, which comprises at least one bowl-shaped form facing towards an interior of the brewing container, wherein at least one hole is provided in a bottom of the bowl-shaped form and wherein at least one pressure-regulating mechanism is provided in the bowl-shaped form, wherein the bowl-shaped form is closed with a lock and wherein one or more vapor deviation channels or a vapor outlet gap are formed between the lock and the brewing container.

2. The apparatus of claim 1, wherein the lock with a screen on the outside, wherein the screen does not have any holes or the like, follows the contour of the brewing container and closes the brewing container planarely.

3. The apparatus of claim 1, wherein the lock comprises one or more elements shielding electromagnetic radiation, which partly or entirely shield parts of or the entire pressure-regulating mechanism from electromagnetic radiation.

4. The apparatus of claim 1, wherein bowl-shaped form is provided with a second pressure-regulating mechanism for the case of an excessive increase in pressure, which is provided such that the lock is entirely removed from the brewing container.

5. The apparatus of claim 1, wherein the pressure-regulating mechanism is permanently attached to the lock or is part of it.

6. The apparatus of claim 5, wherein a shield and a spring mechanism are part of the pressure-regulating mechanism (76), and are made from the same material.

7. The apparatus of claim 5, wherein the lock and the pressure-regulating mechanism are entirely made from one material.

8. The apparatus of claim 1, wherein the brewing container consists of transparent material and parts of the brewing container comprise a structure such that these parts seem diffuse to non-transparent.

9. A method for manufacturing a safety apparatus for limiting a pressure in a brewing container for beverages, which comprises at least one bowl-shaped form facing towards the interior, wherein at least one hole is provided in a bottom of the bowl-shaped form and wherein at least one pressure-regulating mechanism is provided in the bowl-shaped form, the method comprising first manufacturing the brewing container, the pressure-regulating mechanism and the lock, and then manufacturing the safety apparatus for limiting the pressure by inserting first the pressure-regulating mechanism and then the lock into the bowl-shaped form.

10. The method of claim 9, further comprising manufacturing the lock with the pressure-regulating mechanism entirely in a single operating step and subsequently manufacturing the safety apparatus for limiting the pressure by inserting the lock in the bowl-shaped form.
